(19) United States
(12) Patent Application Publication
(10) Pub. No.: US 2026/0311655 A1
(43) Pub. Date: Oct. 8, 2026

(54) ELECTRONIC APPARATUS AND CONTROL METHOD THEREOF

(71) Applicant: SAMSUNG ELECTRONICS CO., LTD., Suwon-si (KR)

(72) Inventor: Kihyung KANG, Suwon-si (KR)

(73) Assignee: SAMSUNG ELECTRONICS CO., LTD., Suwon-si (KR)

(21) Appl. No.: 19/460,689

(22) Filed: Jan. 27, 2026

Related U.S. Application Data
(63) Continuation of application No. PCT/KR2025/022338, filed on Dec. 19, 2025.

(30) Foreign Application Priority Data
Jan. 6, 2025 (KR) 10-2025-0001352
Feb. 28, 2025 (KR) 10-2025-0027069

(51) Int. Cl. G09G 3/34; G02F 1/167; G02F 1/1685

(52) U.S. Cl. CPC G09G 3/344; G02F 1/167; G02F 1/1685; G09G 2320/0247; G09G 2320/0257

(57) ABSTRACT

An electronic apparatus is caused to, when executed individually or collectively by at least one processor: identify a first color corresponding to a first pixel among a plurality of pixels of a first screen and store the first color in the memory; identify a second color corresponding to a first pixel among a plurality of pixels of a second screen output after the first screen and compare the second color with the first color; switch, based on the second color being different from the first color, the first color to the second color based on a predetermined color sequence; and display the second screen based on the second color to which the first color is switched, wherein the predetermined color sequence is based on a driving order of a plurality of colors and a driving waveform to be applied to switch between colors among the plurality of colors.

### CROSS-REFERENCE TO RELATED APPLICATION(S)

This application is a bypass continuation of International Application No. PCT/KR2025/022338, filed on Dec. 19, 2025, which is based on and claims priority to Korean Patent Application No. 10-2025-0001352, filed on Jan. 6, 2025, and Korean Patent Application No. 10-2025-0027069, filed on Feb. 28, 2025 in the Korean Intellectual Property Office, the disclosures of which are incorporated by reference herein in their entireties.

### BACKGROUND

### 1. Field

The present disclosure relates to an electronic apparatus and a control method thereof.

### 2. Description of the Related Art

With recent advancements in color expression technology for electrophoretic displays (EPDs), a method for seamless screen switching has been developed.

An EPD refers to a device for displaying a desired image by applying a voltage to each pixel to move pigment particles. Unlike other display devices, the EPD may maintain a position of the pigment particle even if the voltage is removed, thereby continuously maintaining a screen without power consumption.

Conventionally, EPD screen switching may involve performing erasing and activation operations for applying opposite voltages to the pigment particles in each pixel and mixing the pigment particles. However, the erasing and activation operations may cause afterimages of a previous screen to remain on a switched screen, resulting in flickering.

### SUMMARY

According to an aspect of an example embodiment of the present disclosure, provided is an electronic apparatus including: a display; a memory storing instructions; and at least one processor including processing circuitry.

When executed individually or collectively by the at least one processor, the instructions may cause the electronic apparatus to: identify a first color corresponding to a first pixel among a plurality of pixels of a first screen and store the first color in the memory; identify a second color corresponding to a first pixel among a plurality of pixels of a second screen to be output after the first screen and compare the second color with the first color; switch, based on the second color being different from the first color, the first color to the second color based on a predetermined color sequence; and display the second screen on the display based on the second color to which the first color is switched, wherein the predetermined color sequence is based on a driving order of a plurality of colors and a driving waveform to be applied to switch between colors among the plurality of colors.

When executed individually or collectively by the at least one processor, the instructions may cause the electronic apparatus to: identify a number of driving for switching the first color to the second color and at least one stepwise driving waveform to be applied to switch from the first color to the second color, based on the predetermined color sequence, and switch the first color to the second color based on the number of driving and the at least one stepwise driving waveforms.

When executed individually or collectively by the at least one processor, the instructions may cause the electronic apparatus to switch the first color to the second color by applying the at least one stepwise driving waveform to the first pixel as many times as the number of driving.

The at least one stepwise driving waveform may include a plurality of stepwise driving waveforms, and when executed individually or collectively by the at least one processor, the instructions may cause the electronic apparatus to switch the first color by applying a first-stage driving waveform among the plurality of stepwise driving waveforms to the first pixel, and re-switch the switched first color by applying a second-stage driving waveform among the plurality of stepwise driving waveforms based on the switched first color being different from the second color.

When executed individually or collectively by the at least one processor, the instructions may cause the electronic apparatus to display the second screen on the display based on the first color corresponding to the first pixel, based on the second color being the same as the first color.

When executed individually or collectively by the at least one processor, the instructions may cause the electronic apparatus to identify a first region of the first screen that is to be updated with new content based on a position of each of the plurality of pixels of the first screen, and switch a color of a second pixel in the first region to a color corresponding to the new content for the second pixel, based on the predetermined color sequence.

The electronic apparatus may be configured as an electrophoretic display (EPD) device configured to display a color of each pixel by using electronic ink.

The driving waveform may be a voltage-varying waveform generated based on a voltage sufficient to move a pigment particle included in the first pixel and a voltage application time.

When executed individually or collectively by the at least one processor, the instructions may cause the electronic apparatus to: switch first colors of the plurality of pixels of the first screen to second colors of the plurality of pixels of the second screen by applying respective driving waveforms according to the driving order of the plurality of colors.

A number of driving to switch the first screen to the second screen may be the same as a number of a plurality of colors represented by the plurality of pixels.

According to an aspect of an example embodiment of the present disclosure, provided is a method of controlling an electronic apparatus, the method including: identifying a first color corresponding to a first pixel among a plurality of pixels of a first screen and storing the first color in the electronic apparatus; identifying a second color corresponding to a first pixel among a plurality of pixels of a second screen to be output after the first screen and comparing the second color with the first color; switching, based on the second color being different from the first color, the first color to the second color based on a predetermined color sequence; and displaying the second screen on the display based on the second color to which the first color is switched, wherein the predetermined color sequence is based on a driving order of a plurality of colors and a driving waveform to be applied to switch between colors among the plurality of colors.

According to an aspect of an example embodiment of the present disclosure, provided is a non-transitory computer-readable storage medium storing computer instructions that, when executed by a processor of an electronic apparatus, cause the electronic apparatus to perform: identifying a first color corresponding to a first pixel among a plurality of pixels of a first screen and storing the first color in the electronic apparatus; identifying a second color corresponding to a first pixel among a plurality of pixels of a second screen to be output after the first screen and comparing the second color with the first color; switching, based on the second color being different from the first color, the first color to the second color based on a predetermined color sequence; and displaying the second screen on the display based on the second color to which the first color is switched, wherein the predetermined color sequence is based on a driving order of a plurality of colors and a driving waveform to be applied to switch between colors among the plurality of colors.

### BRIEF DESCRIPTION OF DRAWINGS

The above and other aspects, features, and/or advantages of certain embodiments of the disclosure will be more apparent from the following detailed description taken in conjunction with the accompanying drawings.

FIG. 1 is a diagram illustrating an operation of an electronic apparatus according to at least one embodiment.

FIG. 2 is a block diagram illustrating a configuration of an electronic apparatus according to at least one embodiment.

FIG. 3 is a diagram illustrating a first pixel color comparison process of an electronic apparatus according to at least one embodiment.

FIG. 4 is a diagram illustrating a predetermined color sequence in an electronic apparatus according to at least one embodiment.

FIG. 5 is a diagram illustrating a color switching process of an electronic apparatus according to at least one embodiment.

FIG. 6 is a diagram illustrating a driving waveform of an electronic apparatus according to at least one embodiment.

FIG. 7 is a diagram illustrating a color switching process of an electronic apparatus based on a stepwise driving waveform according to at least one embodiment.

FIG. 8 is a diagram illustrating a screen switching process of an electronic apparatus according to at least one embodiment.

FIG. 9 is a flowchart illustrating a color switching process of an electronic apparatus according to at least one embodiment.

FIG. 10 is a diagram illustrating a local update process of an electronic apparatus according to at least one embodiment.

FIG. 11 is a flowchart illustrating an overall operation method of an electronic apparatus according to at least one embodiment.

### DETAILED DESCRIPTION

General terms that are currently widely used are selected as terms used in various embodiments of the present disclosure in consideration of their functions in the present disclosure, and may be changed based on the intention of those skilled in the art or a judicial precedent, the emergence of a new technique, or the like. In addition, in a specific case, terms arbitrarily chosen by an applicant may exist. In this case, the meanings of such terms are mentioned in detail in corresponding descriptions of the present disclosure. Therefore, the terms used in the present disclosure need to be defined on the basis of the meanings of the terms and the contents throughout the present disclosure rather than simple names of the terms.

In the present disclosure, the expression such as “have”, “may have”, “include”, or “may include”, indicates the presence of a corresponding feature (for example, a numerical value, a function, an operation, or a component such as a part), and does not exclude the presence of an additional feature.

An expression such as “at least one of A or/and B” may indicate either “A or B”, or “both of A and B.”

Expressions such as “first” and “second”, used in the present disclosure may indicate various components regardless of the sequence or importance of the components. The expression is used only to distinguish one component from another component, and does not limit the corresponding component.

If any component (for example, a first component) is mentioned to be “(operatively or communicatively) coupled with/to” or “connected to” another component (for example, a second component), it should be understood that the any component is directly coupled to another component or may be coupled to another component through yet another component (for example, a third component).

A term of a singular number may include its plural number unless explicitly indicated otherwise in the context. It should be understood that a term “include” or “have” used in this application specifies the presence of features, numerals, steps, operations, components, parts, or combinations thereof, which are mentioned in the specification, and does not preclude the presence or addition of one or more other features, numerals, steps, operations, components, parts, or combinations thereof.

In the present disclosure, a “module” or a “~er/~or” may perform at least one function or operation, and be implemented by hardware, software, or a combination of hardware and software. In addition, a plurality of “modules” or a plurality of “~ers/~ors” may be integrated in at least one module and be implemented by the processor (not shown) except for a “module” or a “~er/or” that needs to be implemented by a specific hardware.

In the present disclosure, a term “user” may refer to a person using an electronic apparatus or a device used by the person.

Hereinafter, an embodiment of the present disclosure is described in more detail with reference to the accompanying drawings.

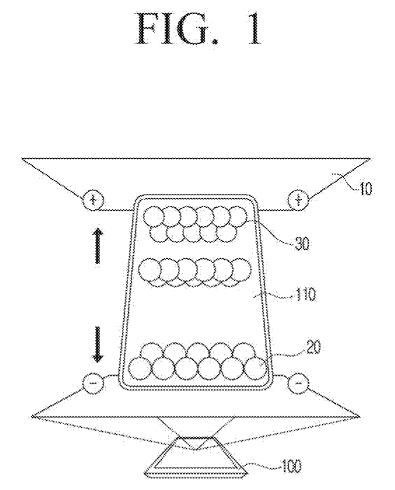

FIG. 1 is a diagram illustrating an operation of an electronic apparatus according to at least one embodiment.

According to an embodiment, an electronic apparatus 100 may switch a first color displayed on a display 110 to a second color based on a predetermined color sequence. Here, the electronic apparatus 100 may be implemented as any of various types of electronic apparatuses, such as electrophoretic display (EPD), electronic paper (E-paper), electronic ink (E-ink) display, smart television (TV), digital signage, monitor, kiosk, tablet personal computer (PC), electronic picture frame, mobile phone, large format display (LFD), digital information display (DID), video wall, and projector display. However, in some cases, the electronic apparatus 100 may be implemented as an image processing device (e.g., set-top box or connected box) that is connected to the electronic apparatus and provides an image.

According to an embodiment, the electronic apparatus 100 may be configured as an electrophoretic display (EPD) device for displaying a color of each pixel by using electronic ink. For convenience of description, the present disclosure assumes the electronic apparatus 100 as the electrophoretic display (EPD).

For example, the electronic apparatus 100 may display data in white or black based on a voltage applied across both ends thereof, and include microcapsules 20 and 30 and a substrate 10 to which electrophoresis is applied.

The microcapsules 20 and 30 include fine electrophoretic particles, specifically pigment particles in white, black, red, or the like. The substrate 10 may form a thin-film transistor (TFT) circuit or electrode and serve as a physical layer for disposing the electrophoretic particles, i.e., the microcapsules 20 and 30, thereon.

The electronic apparatus 100 may display colors on the substrate 10 by moving the pigment particles by applying the voltage (e.g., an electric field or a waveform) to the microcapsules 20 and 30. Unlike in a light-emitting diode (LED) display or a liquid crystal display (LCD) display, in the EPD display, the pigment particles may maintain their states even if power is turned off, thereby displaying colors on the display as they are.

FIG. 1 illustrates a general structure of the electronic apparatus 100. The electronic apparatus 100 may include a plurality of pixels, and each pixel may include the plurality of microcapsules 20 and 30. If a specific voltage is applied to a specific pixel, the microcapsule 20 disposed at a lower end of the pixel may move to an upper end of the pixel. Here, the microcapsule 30 disposed at the upper end may be disposed on the substrate 10, and the electronic apparatus 100 may thus display colors by using the pigment particle disposed on the substrate 10.

For example, the electronic apparatus 100 may include the plurality of pixels, each including a different color microcapsule (or pigment particle). For example, each pixel of the electronic apparatus 100 may include white, blue, red, and yellow pigment particles. Each pigment particle may have a different charge amount and particle size. The electronic apparatus 100 may move each pigment particle (white, blue, red, or yellow pigment particle) by applying a different voltage thereto.

In the related art, an existing electronic apparatus may display colors by moving the pigment particles, and then perform erasing and activation processes on all pixels during a process of switching to a next screen. The erasing and activation processes may involve applying opposite voltages to all the pixels and specific waveforms thereto to mix the pigment particles for screen switching. However, performing such processes may leave afterimages of a previous screen and cause flickering, which may be perceived by a user’s eyes.

Accordingly, the electronic apparatus 100 may perform the screen switching based on the predetermined color sequence without performing the erasing and activation processes on the plurality of pigment particles of different colors included in the pixels.

Hereinafter, the following description describes various embodiments in which the electronic apparatus 100 switches the first color of a first screen to the second color of a second screen to be output after the first screen based on the predetermined color sequence with reference to the drawings. In the following description, the term “first color” may include a color of a pixel of the first screen before switching based on the predetermined color sequence as well as a color of the pixel of the first screen obtained as a result of each switching based on the predetermined color sequence, and the term “second color” may refer to a color of a corresponding pixel of the second screen, to which the first color is to be switched (that is, a target color to be finally displayed on the second screen).

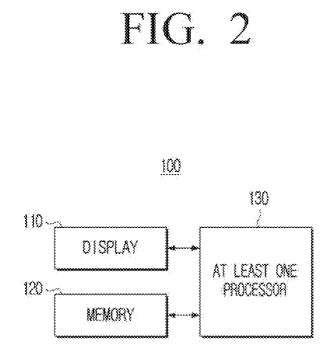

FIG. 2 is a block diagram illustrating a configuration of an electronic apparatus according to at least one embodiment.

Referring to FIG. 2, the electronic apparatus 100 may include the display 110, a memory 120, and at least one processor 130. However, the present disclosure is not limited thereto, and the electronic apparatus 100 may be implemented to exclude some components, and/or may be implemented to further include other components.

The display 110 may display a content screen based on a switched color. The display 110 may be implemented as a display including a self-luminous element or a display including a non-luminous element and a backlight. For example, the display may be implemented as various types of displays such as, for example but not limited to, a liquid crystal display (LCD), an organic light emitting diode (OLED), a light-emitting diode (LED), a micro LED, a mini LED, a plasma display panel (PDP), a quantum dot (QD) display, and a quantum dot light-emitting diode (QLED). The display 110 may also include a driving circuit, a backlight unit, or the like, which may be implemented by using, for example but not limited to, an amorphous silicon thin film transistor (a-si TFT), a low temperature poly silicon (LTPS) TFT, or an organic TFT (OTFT).

The memory 120 may store at least one instruction, data, program, or the like related to an operation of the electronic apparatus 100. For example, the memory 120 may store speech feature information corresponding to a speaker.

The memory 120 may be implemented as a memory embedded in the electronic apparatus 100 or as a memory detachable from the electronic apparatus 100, depending on a data storage purpose. For example, data for operating the electronic apparatus 100 may be stored in the memory embedded in the electronic apparatus 100, while data for expanding a function of the electronic apparatus 100 may be stored in the memory detachable from the electronic apparatus 100.

The memory embedded in the electronic apparatus 100 may be implemented as, for example but not limited to, at least one of a volatile memory (e.g., a dynamic RAM (DRAM)), a static RAM (SRAM), or a synchronous dynamic RAM (SDRAM)) or a non-volatile memory (e.g., a one time programmable ROM (OTPROM), a programmable ROM (PROM), an erasable and programmable ROM (EPROM), an electrically erasable and programmable ROM (EEPROM), a mask ROM, a flash ROM, a flash memory (e.g., a NAND flash or a NOR flash), a hard drive, or a solid state drive (SSD)).

The memory 120 may be implemented as a single memory storing data generated from various operations according to the present disclosure, is not limited thereto, and may be implemented to include a plurality of memories that each store different types of data or data generated at different stages.

The at least one processor 130 may control overall operations of the electronic apparatus 100. In detail, at least one processor 130 may be connected to each component of the electronic apparatus 100 and control the overall operations of the electronic apparatus 100. For example, at least one processor 130 may be electrically connected to the display 110 and the memory 120, and control the overall operations of the electronic apparatus 100. At least one processor 130 may include processing circuitry and may include one or more processors.

At least one processor 130 may perform the operation of the electronic apparatus 100 according to the various embodiments by executing at least one instruction stored in the memory 120.

At least one processor 130 may include, for example but not limited to, at least one of a central processing unit (CPU), a graphics-processing unit (GPU), an accelerated processing unit (APU), a many integrated core (MIC), a digital signal processor (DSP), a neural processing unit (NPU), a hardware accelerator, or a machine learning accelerator. At least one processor 130 may control one or any combination of other components of the electronic apparatus, and may perform operations related to communication or data processing. At least one processor 130 may execute at least one program or instruction stored in the memory 120. For example, at least one processor may perform a method according to at least one embodiment of the present disclosure by executing at least one instruction stored in the memory 120.

If a method according to at least one embodiment of the present disclosure includes a plurality of operations, the plurality of operations may be performed by one processor, or may be performed by a plurality of processors. For example, if a first operation, a second operation, and a third operation are performed by the method according to at least one embodiment, the first operation, the second operation, and the third operation may all be performed by a first processor, or the first operation and the second operation may be performed by the first processor (e.g., a general-purpose processor) and the third operation may be performed by a second processor (e.g., an artificial intelligence-specific processor).

At least one processor 130 may be implemented as a single-core processor including a single core, or as at least one multi-core processor including multiple cores (e.g., homogeneous multiple cores or heterogeneous multiple cores). If at least one processor 130 is implemented as the multi-core processor, each of the multiple cores included in the multi-core processor may include an internal memory of the processor, such as a cache memory or an on-chip memory, and a common cache shared by the multiple cores may be included in the multi-core processor. In addition, each of the multiple cores (or some of the multiple cores) included in the multi-core processor may independently read and perform a program instruction for implementing the method according to at least one embodiment of the present disclosure, or all (or some) of the multiple cores may be linked to read and perform the program instruction for implementing the method according to at least one embodiment of the present disclosure.

If the method according to at least one embodiment of the present disclosure includes a plurality of operations, the plurality of operations may be performed by the single core among the multiple cores included in the multi-core processor, or may be performed by the multiple cores. For example, if the first operation, the second operation, and the third operation are performed using the method according to at least one embodiment, the first operation, the second operation, and the third operation may all be performed by a first core included in the multi-core processor, or the first operation and the second operation may be performed by the first core included in the multi-core processor and the third operation may be performed by a second core included in the multi-core processor.

In the embodiments of the present disclosure, the processor may indicate a system on a chip (SoC) integrating at least one processor and other electronic components, the single-core processor, the multi-core processor, or a core included in the single-core processor or the multi-core processor. Here, the core may be implemented as the CPU, the GPU, the APU, the MIC, the DSP, the NPU, the hardware accelerator, or the machine learning accelerator. However, an embodiment of the present disclosure is not limited thereto. For convenience of description, at least one processor 130 is hereinafter referred to as the processor 130.

According to an embodiment, the processor 130 may identify the first color corresponding to a first pixel among the plurality of pixels of the first screen and store the first color in the memory 120. The first pixel may be a pixel disposed in a region of the first screen. The first color may be any one of white, black, blue, green, red, and yellow, for example but not limited to.

According to an embodiment, the processor 130 may identify the second color corresponding to the first pixel among the plurality of pixels of the second screen to be output after the first screen and compare the second color with the first color. An operation of comparing the first color with the second color may be an operation of comparing whether the first and second colors are the same.

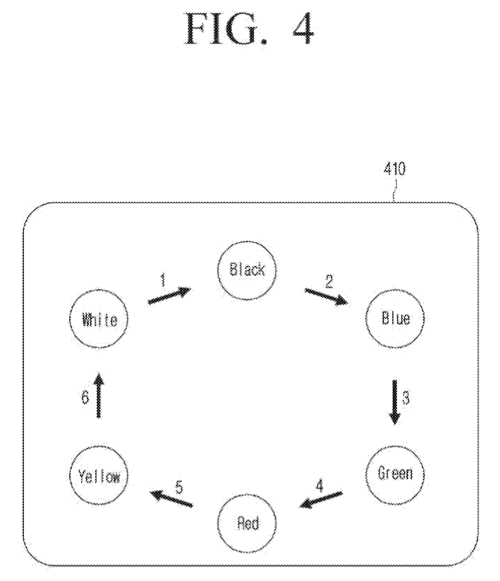

According to an embodiment, the processor 130 may switch the first color to the second color based on the predetermined color sequence if the second color is not the same as the first color. The predetermined color sequence may be a color sequence established based on a driving order of a plurality of colors and a driving waveform capable of switching between colors. A detailed description of the predetermined color sequence is described below with reference to FIG. 4.

According to an embodiment, the processor 130 may display the second screen on the display 110 based on the switched second color.

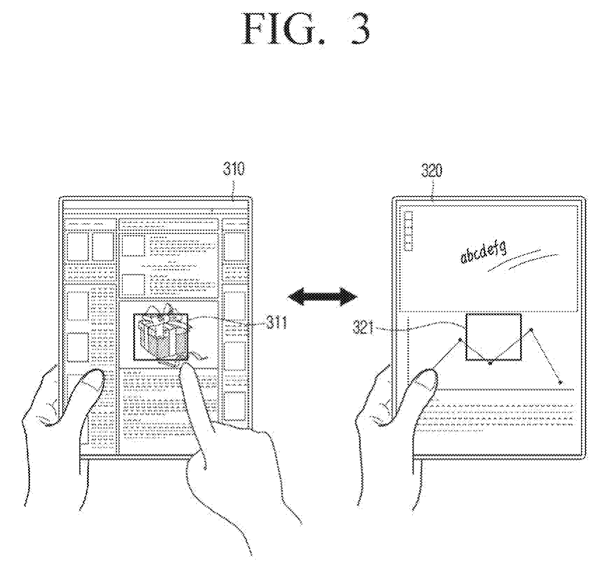

FIG. 3 is a diagram illustrating a first pixel color comparison process of the electronic apparatus according to at least one embodiment.

According to an embodiment, the electronic apparatus 100 may identify the first color corresponding to a first pixel 311 among a plurality of pixels of a first screen 310 and store the first color in the memory 120. The electronic apparatus 100 may identify the first color based on a color of the pigment particle disposed at the uppermost side within the first pixel (i.e., a substrate layer).

For example, in the electronic apparatus 100, a specific voltage may be applied to all the pixels during a manufacturing process, thus allowing an entire screen of the display to have one of a plurality of colors. For example, in the electronic apparatus 100, the specific voltage may be applied to all the pixels, thus allowing the entire screen to be white.

According to an embodiment, the electronic apparatus 100 may identify the second color corresponding to a first pixel 321 among a plurality of pixels of a second screen 320 output after the first screen. The electronic apparatus 100 may compare the first color with the second color.

For example, the electronic apparatus 100 may include pigment particles of four colors within a pixel, and display six colors based on the pigment particles of the four colors. For example, the electronic apparatus 100 may include pigment particles of white, blue, red, and yellow within each of the plurality of pixels, and display colors of white, black, blue, green, red, and yellow based on the pigment particles.

For example, if the white pigment particle is disposed at the uppermost side, the electronic apparatus 100 may display the first pixel as white. For example, if the blue pigment particle and the yellow pigment particle are disposed at the uppermost side, the electronic apparatus 100 may display the first pixel as green. For example, if the blue pigment particle and the red pigment particle are disposed at the uppermost side, the electronic apparatus 100 may display the first pixel as black.

Referring to FIG. 3, the electronic apparatus 100 may identify the first color based on the color of the pigment particle disposed at the uppermost side of the first pixel 311 among the plurality of pixels of the first screen 310. Similarly, the electronic apparatus 100 may identify the second color based on the pigment particle disposed at the uppermost side of the first pixel 321 among the plurality of pixels of the second screen 320 output after the first screen 310. For example, the black pigment particle (or the blue and red pigment particles) may be disposed at the uppermost side of the first pixel 311 of the first screen 310, and the first color may thus be black. For example, the white pigment particle may be disposed at the uppermost side of the first pixel 321 of the second screen 320, and the second color may thus be white.

The electronic apparatus 100 may compare the first color with the second color to determine whether the first and second colors are the same.

FIG. 4 is a diagram illustrating the predetermined color sequence in the electronic apparatus according to at least one embodiment.

According to an embodiment, the electronic apparatus 100 may switch the first color to the second color based on a predetermined color sequence 410 if the second color is not the same as the first color.

A color driving order set in the predetermined color sequence 410 may be determined based on the charge amounts and particle sizes of the pigment particles. The pigment particles may have different particle sizes and charge amounts. The pigment particle having a greater charge amount may be disposed on an upper side of the pixel at a faster rate than the pigment particle having a smaller charge amount if the same voltage is applied thereto. The pigment particle having a larger particle size may be disposed on the upper side of the pixel at a slower rate than the pigment particle having a smaller particle size.

That is, the color driving order may be determined based on the particle size and charge amount of the pigment particle, and the predetermined color sequence 410 may be established based on the color driving order.

The predetermined color sequence 410 may be determined based on different driving waveforms for switching between the colors. For example, switching the color from white to black may require a first-stage driving waveform, and switching the color from black to blue may require a second-stage driving waveform. That is, the electronic apparatus 100 may switch the color from white to black if the first-stage driving waveform is applied thereto, and from black to blue if the second-stage driving waveform is applied thereto.

The term “predetermined color sequence” is not limited, and may also be referred to as a color output sequence or a color driving sequence. However, the above terms are referred to as the predetermined color sequence in the present disclosure.

Referring to FIG. 4, the predetermined color sequence 410 may include a driving order of white, black, blue, green, red, and yellow. However, the above-described order is only an example, and a different driving order may be set.

The electronic apparatus 100 may switch the color from white to black if the first-stage driving waveform is applied thereto. The electronic apparatus 100 may switch the color from black to blue if the second-stage driving waveform is applied thereto.

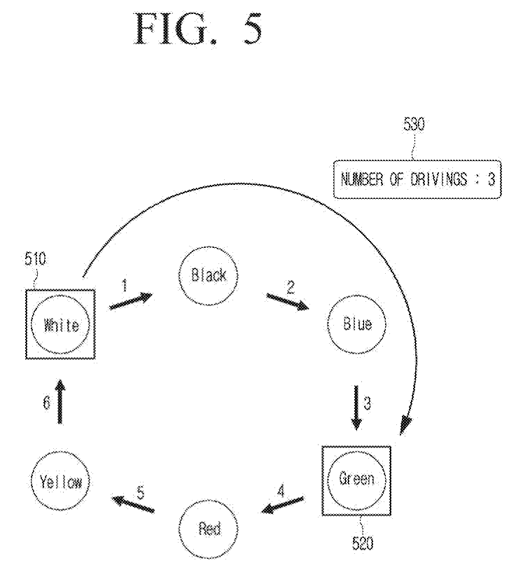

FIG. 5 is a diagram illustrating a color switching process of the electronic apparatus according to at least one embodiment.

According to an embodiment, the electronic apparatus 100 may identify a number of drivings 530 for switching the first color to the second color based on the predetermined color sequence 410. The electronic apparatus 100 may switch the first color to the second color based on the identified number of drivings 530.

Referring to FIG. 5, if a first color 510 is white and a second color 520 is green, the electronic apparatus 100 may identify the number of drivings 530 for switching the first color 510 to the second color 520 as three. The electronic apparatus 100 may perform three color drivings based on the predetermined color sequence 410 (that is, from white to black, then black to blue, and then from blue to green) on the first pixel displayed in the first color 510 to switch the first color 510 to the second color 520.

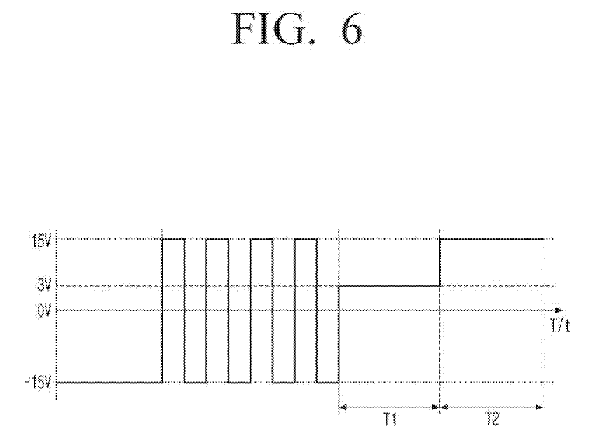

FIG. 6 is a diagram illustrating an example of the driving waveform of the electronic apparatus according to at least one embodiment.

According to an embodiment, the electronic apparatus 100 may identify a stepwise driving waveform capable of switching between colors based on the predetermined color sequence 410, and switch the first color to the second color based on the number of driving waveforms and the stepwise driving waveform capable of switching between colors.

For example, the driving waveform may be a voltage-varying waveform generated based on the voltage sufficient to move the pigment particles included in the first pixel and a voltage application time. The driving waveform may refer to a time-varying voltage or a current signal that represents a color-to-color switching waveform. The driving waveform may include the first-stage driving waveform, the second-stage driving waveform, or the like for each color-to-color switching stage.

The stepwise driving waveform capable of switching between colors may refer to a driving waveform to be applied to the electronic apparatus 100 for switching between the colors. The stepwise driving waveform may have a different waveform shape, frequency, amplitude, and/or duty cycle. For example, among the stepwise driving waveforms, the first-stage driving waveform and the second-stage driving waveform may include different waveform shapes, frequencies, amplitudes, and/or duty cycles.

However, the term “driving waveform” is not limited, and may be referred to in various ways, such as driving signal, input waveform, driving voltage, driving current, or driving time. However, in the present disclosure, the above terms are collectively referred to as the driving waveform.

FIG. 6 illustrates an example of the driving waveform. Each stepwise driving waveform may be a driving waveform set based on a different voltage application time and voltage value. A horizontal axis of the graph illustrated in FIG. 6 may represent the time, and the vertical axis thereof may represent the voltage.

For example, the first-stage driving waveform may refer to a driving waveform obtained by applying a voltage of 3 V during a time T1 and a voltage of 15 V during a time T2. The electronic apparatus 100 may move the pigment particle by applying the voltage of 3 V during the time T1 and the voltage of 15 V for the time T2 based on the first-stage driving waveform.

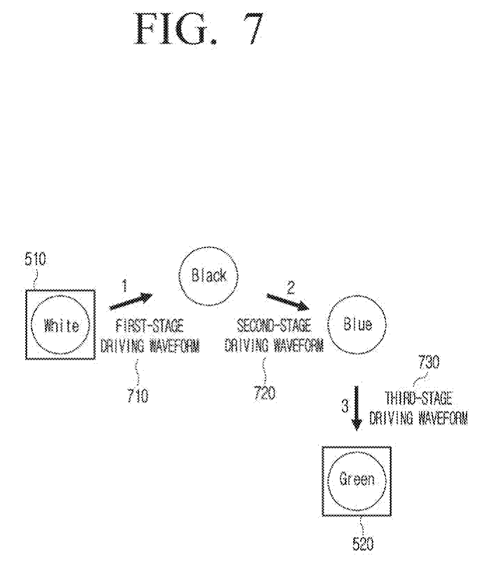

FIG. 7 is a diagram illustrating a color switching process of the electronic apparatus based on the stepwise driving waveform according to at least one embodiment.

According to an embodiment, the electronic apparatus 100 may switch the first color to the second color by applying the stepwise driving waveform capable of switching between colors to the first pixel as many times as the identified number of driving waveforms.

For example, if the identified number of drivings is two, the electronic apparatus 100 may switch the colors by applying the first-stage driving waveform and the second-stage driving waveform to the first pixel.

According to an embodiment, the electronic apparatus 100 may switch the first color by applying the first-stage driving waveform among the stepwise driving waveforms to the first pixel, and re-switch the switched first color by applying the second-stage driving waveform among the stepwise driving waveforms to the first pixel if the switched first color and the second color are compared and determined as not being the same.

For example, the electronic apparatus 100 may apply the first-stage driving waveform to the first pixel and then compare the switched first color with the second color. If the switched first color and the switched second color are the same, the electronic apparatus 100 may maintain a current state without applying any more voltage to the first pixel.

However, if the switched first color and the second color are not the same, the electronic apparatus 100 may re-switch the color by applying the second-stage driving waveform to the first pixel. After repeatedly performing the above operation, if the stepwise switched first color and the second color are the same, the electronic apparatus 100 may maintain the current state of the first pixel.

According to an embodiment, the number of times each stepwise driving waveform is applied to the first pixel may be determined based on the identified number of drivings.

Referring to FIG. 7, if the first color 510 displayed on the first pixel of the first screen is white, and the second color 520 to be displayed on the first pixel of the second screen is green, the electronic apparatus 100 may identify a total of three driving orders for switching the color from white to black, black to blue, and blue to green based on the predetermined color sequence 410.

For example, the electronic apparatus 100 may identify the driving waveform for each color switching stage based on the predetermined color sequence 410. For example, the electronic apparatus 100 may identify a first-stage driving waveform 710 for switching the color from white to black, a second-stage driving waveform 720 for switching the color from black to blue, and a third-stage driving waveform 730 for switching the color from blue to green.

For example, the electronic apparatus 100 may switch the first color from white to black by applying the first-stage driving waveform 710 to the first pixel. The electronic apparatus 100 may compare the switched black color with the second color, and if the colors are not the same, the electronic apparatus 100 may apply the second-stage driving waveform 720 to the first pixel.

However, this configuration is only an optional embodiment, and the electronic apparatus 100 may not compare the switched color with the second color after applying the first-stage driving waveform 710 to the first pixel. That is, if the number of drivings is identified, the electronic apparatus 100 may apply the driving waveform to the first pixel as many times as the identified number of drivings without comparing the colors each time the driving waveform is applied.

The electronic apparatus 100 may switch the first color from black to blue by applying the second-stage driving waveform 720 to the first pixel, and switch the first color from blue to green by applying the third-stage driving waveform 730 to the first pixel.

For example, if the first color is blue and the second color is green, the electronic apparatus 100 may identify the number of drivings as one based on the predetermined color sequence 410, and identify the third-stage driving waveform 730 for switching the color from blue to green. The electronic apparatus 100 may switch the first color to the second color by applying the third-stage driving waveform 730 to the first pixel.

In an embodiment, the electronic apparatus 100 may not apply the driving waveform as many times as the number of drivings identified to switch the first color from white to green. The electronic apparatus 100 may identify the driving waveform for directly switching the color from white to green, and switch the color based on the identified driving waveform. That is, if the driving waveform for directly switching a specific color to another specific color is identified, the electronic apparatus 100 may switch the color based on the identified driving waveform without switching the color based on the predetermined color sequence 410.

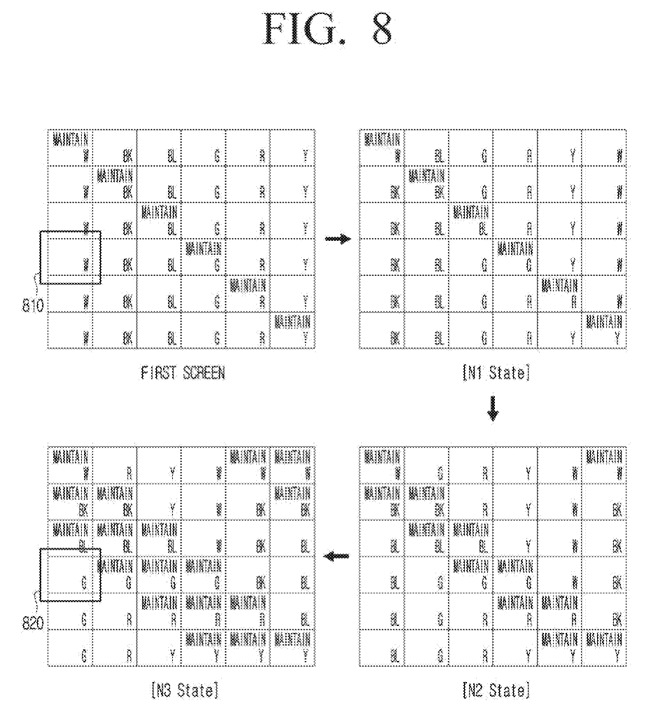

FIG. 8 is a diagram illustrating a screen switching process of the electronic apparatus according to at least one embodiment.

According to an embodiment, the electronic apparatus 100 may switch the first color of the first pixel on the first screen to the second color of the first pixel on the second screen based on the predetermined color sequence if the second color is not the same as the first color, and display the second screen on the display 110 based on the first color displayed on the first pixel if the second color is the same as the first color.

According to an embodiment, the electronic apparatus 100 may apply the driving waveform to each of the plurality of pixels. The electronic apparatus 100 may compare the colors of the plurality of pixels of the first screen, after switching, and the second screen, respectively, maintain a color of a corresponding pixel if the colors are the same, and reapply the driving waveform to the corresponding pixel to re-switch the color of the corresponding pixel if the colors are not the same.

FIG. 8 illustrates the first and second screens as 6x6 pixels, a total of 36 pixels. FIG. 8 assumes a pixel disposed at a fourth row and a first column as the first pixel.

The electronic apparatus 100 may identify a first color 810 of the first screen as white (W) based on the pigment particle of the first pixel. If a second color 820 is green (G), the electronic apparatus 100 may identify the number of drivings as three based on the predetermined color sequence 410. The electronic apparatus 100 may identify each stepwise driving waveform based on the predetermined color sequence 410.

The electronic apparatus 100 may switch the first color 810 from white (W) to black (BK) by applying the first-stage driving waveform (e.g., 710 in FIG. 7) to the first pixel (“N1” state). The electronic apparatus 100 may re-switch the switched first color 810 from black (BK) to blue (BL) by applying the second-stage driving waveform (e.g., 720 in FIG. 7) to the first pixel (“N2” state). The electronic apparatus 100 may re-switch the switched first color 810 from blue (BL) to green (G) by applying the third-stage driving waveform (e.g., 730 in FIG. 7) to the first pixel (“N3” state). The electronic apparatus 100 may switch the first color 810 to the second color 820 based on the predetermined color sequence 410. As shown in FIG. 8, in each switching operation, pixels of which the switched first color is the same as the second color, the switched first color is maintained, and for pixels of which the switched first color is not the same as the second color, the switched first color is re-switched based on the predetermined color sequence 410.

In addition, in FIG. 8, as an example, color switching is performed per vertical line. For example, in FIG. 8, pixels of a first column are displayed as white (W) and pixels of a second column are displayed as black (BK) in the first screen, and in “N1” state, the pixels of the first column are switched from white (W) to black (BK) by applying the first-stage driving waveform to the pixels of the first column except for a pixel of which the first color is the same as the second color (that is, the first color in the first screen is maintained in the second screen), while the pixels of the second column are switched from black (BK) to (BL) by applying the second-stage driving waveform to the pixels of the second column except for a pixel for which the first color is the same as the second color.

While not shown in FIG. 8, a number of driving for switching the first screen to the second screen may be the same as a number of colors represented by the plurality of pixels of the first screen. As an example, the plurality of pixels may display six colors of white, black, blue, green, red, and yellow, and six drivings may be performed to switch an entire first screen to the second screen. In each driving of the six drivings, a corresponding driving waveform is applied to pixels except for a pixel of which the first color or the switched first color is the same as the second color.

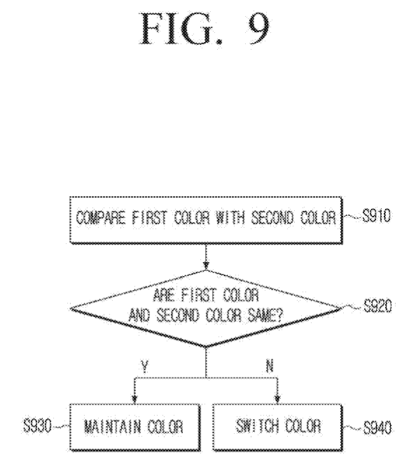

FIG. 9 is a flowchart illustrating a color switching process of the electronic apparatus according to at least one embodiment.

Referring to FIG. 9, in operation 910, the electronic apparatus 100 may identify the first color corresponding to the first pixel of the first screen and the second color corresponding to the first pixel of the second screen, and compare the first color with the second color.

In operation 920, the electronic apparatus 100 may determine whether the first color and the second color are the same.

In operation 930 (i.e., after operation 920-Y), the electronic apparatus 100 may maintain the color of the first pixel if the first color and the second color are the same.

In operation 940 (i.e., after operation 920-N), the electronic apparatus 100 may switch the first color to the second color based on the predetermined color sequence 410 if the first color and the second color are different.

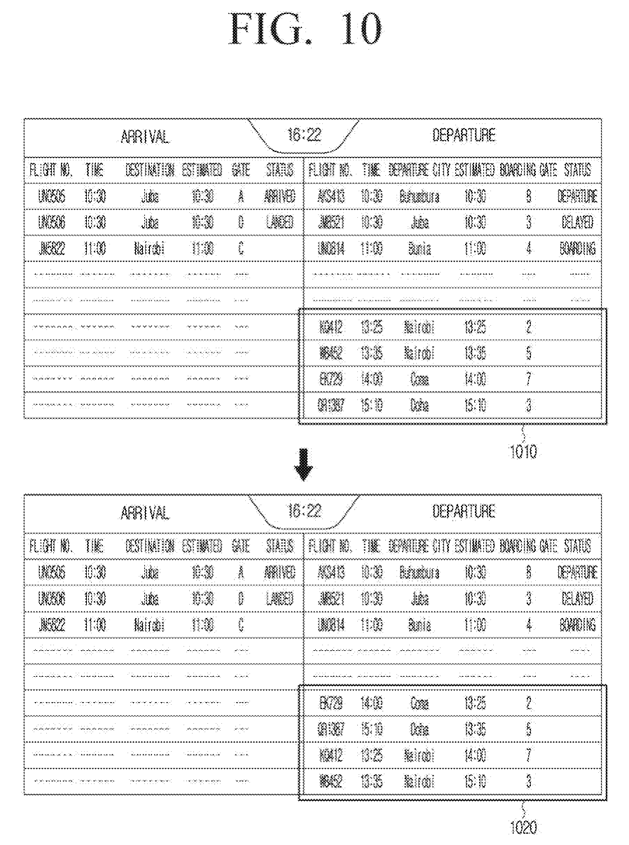

FIG. 10 is a diagram illustrating a local update process of the electronic apparatus according to at least one embodiment.

According to an embodiment, the electronic apparatus 100 may perform a local update on a first region 1010 by identifying the first region 1010 of the first screen that is to be updated with new content based on a position of each of the plurality of pixels of the first screen.

The local update may refer to an operation for updating only data corresponding to a specific region among entire data. That is, the local update may be an operation for updating only the data corresponding to the specific region while maintaining data corresponding to a region other than the specific region.

According to an embodiment, the electronic apparatus 100 may switch the color displayed for each pixel in the first region 1010 to a color corresponding to the new content based on the predetermined color sequence.

The electronic apparatus 100 may compare the color displayed on each of the plurality of pixels included in the first region 1010 with the color corresponding to a position of each pixel in the new content, and change the color of a specific pixel among the plurality of pixels based on the predetermined color sequence if the colors are not the same between the first region 1010 and the new content for the specific pixel.

Referring to FIG. 10, the electronic apparatus 100 may identify the first region 1010 of the first screen, on which the local update is to be performed. The electronic apparatus 100 may compare the color displayed on each pixel of the first region 1010 with the color to be displayed on each pixel of a content 1020 to be updated. Based on a color comparison result, the electronic apparatus 100 may maintain the color of a corresponding pixel if the colors are the same for the corresponding pixel, and change the color of the corresponding pixel based on the predetermined color sequence if the colors are different for the corresponding pixel.

In this case, the electronic apparatus 100 may achieve an animation effect and perform the local update on the first region 1010. That is, the electronic apparatus 100 may switch the color by using the animation effect rather than flickering if the color is switched based on the predetermined color sequence 410.

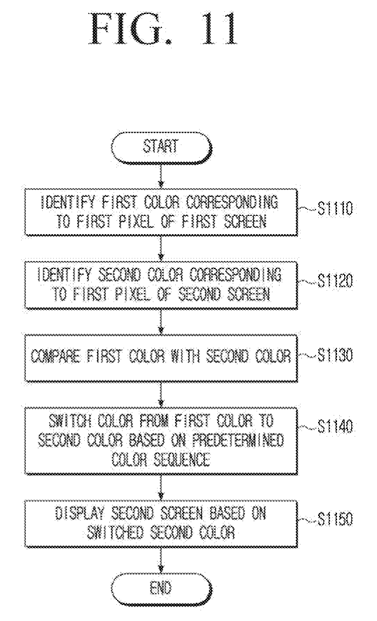

FIG. 11 is a flowchart illustrating an overall operation method of the electronic apparatus according to at least one embodiment.

Referring to FIG. 11, in operation 1110, the electronic apparatus 100 may identify the first color corresponding to the first pixel among the plurality of pixels of the first screen and store the first color in the electronic apparatus 100.

In operation 1120, the electronic apparatus 100 may identify the second color corresponding to the first pixel among the plurality of pixels of the second screen to be output after the first screen.

In operation 1130, the electronic apparatus 100 may compare the first color with the second color to determine whether the colors are the same.

In operation 1140, the electronic apparatus 100 may switch the first color to the second color based on the predetermined color sequence if the second color is not the same as the first color.

In operation 1150, the electronic apparatus 100 may display the second screen based on the switched second color.

Examples of the method for comparing the first color with the second color, and switching the first color to the second color if the colors are not the same, have been described in the above-described embodiment(s), and a description thereof is thus omitted.

The control method described with reference to FIG. 11 may be performed by the electronic apparatus 100 having the configuration shown in FIG. 2, but is not necessarily limited thereto, and may be performed by the electronic apparatus having various configurations.

The various embodiments described above may be implemented independently for each embodiment, or may be entirely or partially implemented in combination with various other embodiments of the present disclosure.

According to the various embodiments described above, the electronic apparatus 100 may switch the screen by using the animation effect without leaving the afterimages or flickering during the process of switching the screen.

Meanwhile, the various embodiments described above may be applied to a product alone as one embodiment, or at least some of the contents may be implemented in combination with another embodiment of the present disclosure.

The various embodiments described above may be implemented in software including an instruction stored on a machine-readable storage medium (for example, a computer-readable storage medium). A machine may be a device that invokes the stored instruction from a storage medium, may be operated based on the invoked instruction, and may include the display device (e.g., the electronic apparatus 100) according to the disclosed embodiments. If the instruction is executed by the processor, the processor may directly perform a function corresponding to the instruction or other components may perform the function corresponding to the instruction under control of the processor. The instruction may include codes provided or executed by a compiler or an interpreter. The machine-readable storage medium may be provided in the form of a non-transitory storage medium. Here, the term “non-transitory” refers to that the storage medium is tangible without including a signal, and does not distinguish whether data are semi-permanently or temporarily stored on the storage medium.

In addition, according to an embodiment, the methods according to the various embodiments described above may be included and provided in a computer program product.

In detail, a non-transitory computer-readable storage medium or a computer program product may be provided that stores computer instructions for performing: an operation for identifying the first color corresponding to the first pixel among the plurality of pixels of the first screen and storing the first color in the electronic apparatus; an operation for identifying the second color corresponding to the first pixel among the plurality of pixels of the second screen to be output after the first screen and comparing the second color with the first color; an operation for switching the first color to the second color based on the predetermined color sequence if the second color is not the same as the first color; and an operation for displaying the second screen based on the switched second color.

The computer program product may be distributed in a form of the machine-readable storage medium (for example, a compact disc read only memory (CD-ROM)), or may be distributed online through an application store (for example, PlayStore^{TM}). In case of the online distribution, at least a part of the computer program product may be at least temporarily stored or temporarily provided on a storage medium such as the memory of a manufacturer server, an application store server, or a relay server.

In addition, computer instructions or programs for performing a control method or the like for an electronic apparatus according to the various embodiments described above may be stored in a non-transitory computer-readable recording medium. The computer instructions stored in the non-transitory computer-readable recording medium may allow a specific device to perform the processing operations of the device according to the various embodiments described above in case that the computer instructions are executed by a processor of the specific device. The non-transitory computer-readable recording medium is not a medium that temporarily stores data, such as a register, a cache, or a memory, and indicates a medium that semi-permanently stores data and is readable by the device. A specific example of the non-transitory computer-readable recording medium may include a compact disk (CD), a digital versatile disk (DVD), a hard disk, a Blu-ray disk, a universal serial bus (USB), a memory card, a read-only memory (ROM), or the like.

Although the example embodiments of the present disclosure have been shown and described hereinabove, the present disclosure is not limited to the above-mentioned example embodiments, and may be variously modified by those skilled in the art to which the present disclosure pertains without departing from the scope and spirit of the present disclosure as defined by the accompanying claims and their equivalents. These modifications should also be understood to fall within the scope and spirit of the present disclosure.

What is claimed is:

1. An electronic apparatus comprising:
a display;
a memory storing instructions; and
at least one processor including processing circuitry,
wherein, when executed individually or collectively by the at least one processor, the instructions cause the electronic apparatus to:
identify a first color corresponding to a first pixel among a plurality of pixels of a first screen and store the first color in the memory;
identify a second color corresponding to a first pixel among a plurality of pixels of a second screen to be output after the first screen and compare the second color with the first color;
switch, based on the second color being different from the first color, the first color to the second color based on a predetermined color sequence; and
display the second screen on the display based on the second color to which the first color is switched,
wherein the predetermined color sequence is based on a driving order of a plurality of colors and a driving waveform to be applied to switch between colors among the plurality of colors.

2. The electronic apparatus as claimed in claim 1, wherein, when executed individually or collectively by the at least one processor, the instructions cause the electronic apparatus to:
identify a number of driving for switching the first color to the second color and at least one stepwise driving waveform to be applied to switch from the first color to the second color, based on the predetermined color sequence; and
switch the first color to the second color based on the number of driving and the at least one stepwise driving waveform.

3. The electronic apparatus as claimed in claim 2, wherein, when executed individually or collectively by the at least one processor, the instructions cause the electronic apparatus to:
switch the first color to the second color by applying the at least one stepwise driving waveform to the first pixel as many times as the number of driving.

4. The electronic apparatus as claimed in claim 2, wherein the at least one stepwise driving waveform comprises a plurality of stepwise driving waveforms,
wherein, when executed individually or collectively by the at least one processor, the instructions cause the electronic apparatus to:
switch the first color by applying a first-stage driving waveform among the plurality of stepwise driving waveforms to the first pixel; and
re-switch the switched first color by applying a second-stage driving waveform among the plurality of stepwise driving waveforms based on the switched first color being different from the second color.

5. The electronic apparatus as claimed in claim 1, wherein, when executed individually or collectively by the at least one processor, the instructions cause the electronic apparatus to:
display the second screen on the display based on the first color corresponding to the first pixel, based on the second color being the same as the first color.

6. The electronic apparatus as claimed in claim 1, wherein, when executed individually or collectively by the at least one processor, the instructions cause the electronic apparatus to:
identify a first region of the first screen that is to be updated with new content, based on a position of each of the plurality of pixels of the first screen; and
switch a color of a second pixel in the first region to a color corresponding to the new content for the second pixel, based on the predetermined color sequence.

7. The electronic apparatus as claimed in claim 1, wherein the electronic apparatus an electrophoretic display (EPD) device configured to display a color of each pixel by using electronic ink.

8. The electronic apparatus as claimed in claim 1, wherein the driving waveform is a voltage-varying waveform generated based on a voltage sufficient to move a pigment particle included in the first pixel and a voltage application time.

9. The electronic apparatus as claimed in claim 1, wherein, when executed individually or collectively by the at least one processor, the instructions cause the electronic apparatus to:
switch first colors of the plurality of pixels of the first screen to second colors of the plurality of pixels of the second screen by applying respective driving waveforms according to the driving order of the plurality of colors.

10. The electronic apparatus as claimed in claim 9, wherein a number of driving to switch the first screen to the second screen is the same as a number of a plurality of colors represented by the plurality of pixels.

11. A method of controlling an electronic apparatus, the method comprising:
identifying a first color corresponding to a first pixel among a plurality of pixels of a first screen and storing the first color in the electronic apparatus;
identifying a second color corresponding to a first pixel among a plurality of pixels of a second screen to be output after the first screen and comparing the second color with the first color;
switching, based on the second color being different from the first color, the first color to the second color based on a predetermined color sequence; and
displaying the second screen based on the second color to which the first color is switched,
wherein the predetermined color sequence is a color sequence established based on a driving order of a plurality of colors and a driving waveform to be applied to switch between colors among the plurality of colors.

12. The method as claimed in claim 11, further comprising:
identifying a number of driving for switching the first color to the second color and at least one stepwise driving waveform, based on the predetermined color sequence; and
switching the first color to the second color based on the number of driving and the at least one stepwise driving waveform.

13. The method as claimed in claim 12, further comprising:
switching the first color to the second color by applying the at least one stepwise driving waveform to the first pixel as many times as the number of driving.

14. The method as claimed in claim 12, wherein the at least one stepwise driving waveform comprises a plurality of stepwise driving waveforms,
the method further comprising:
switching the first color by applying a first-stage driving waveform among the plurality of stepwise driving waveforms to the first pixel; and
re-switching the switched first color by applying a second-stage driving waveform among the plurality of stepwise driving waveforms based on the switched first color being different from the second color.

15. The method as claimed in claim 11, further comprising:
displaying the second screen based on the first color corresponding to the first pixel, based on the second color being the same as the first color.

16. The method as claimed in claim 11, further comprising:
identifying a first region of the first screen that is to be updated with new content based on a position of each of the plurality of pixels of the first screen; and
switching a color of a second pixel in the first region to a color corresponding to the new content for the second pixel, based on the predetermined color sequence.

17. The method as claimed in claim 11, wherein the electronic apparatus an electrophoretic display (EPD) device configured to display a color of each pixel by using electronic ink.

18. The method as claimed in claim 11, wherein the driving waveform is a voltage-varying waveform generated based on a voltage sufficient to move a pigment particle included in the first pixel and a voltage application time.

19. The method as claimed in claim 11, further comprising:
switching first colors of the plurality of pixels of the first screen to second colors of the plurality of pixels of the second screen by applying respective driving waveforms according to the driving order of the plurality of colors.

20. A non-transitory computer-readable storage medium storing computer instructions that, when executed by a processor of an electronic apparatus, cause the electronic apparatus to perform:
identifying a first color corresponding to a first pixel among a plurality of pixels of a first screen and storing the first color in the electronic apparatus;
identifying a second color corresponding to a first pixel among a plurality of pixels of a second screen to be output after the first screen and comparing the second color with the first color;
switching, based on the second color being different from the first color, the first color to the second color based on a predetermined color sequence; and
displaying the second screen based on the second color to which the first color is switched,
wherein the predetermined color sequence is a color sequence established based on a driving order of a plurality of colors and a driving waveform to be applied to switch between colors among the plurality of colors.
